(19) United States
(12) Patent Application Publication
(10) Pub. No.: US 2007/0003167 A1
(43) Pub. Date: Jan. 4, 2007

(54) Interpolation of images

(75) Inventors: Giulio Ferretti, Milano (IT); Paola Carrai, Bangalore (IN); Francesco Zotta, Trieste (IT); Giovanni Ramponi, Trieste (IT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/558,715

(22) PCT Filed: May 25, 2004
(86) PCT No.: PCT/IB04/50767

§ 371 Date: Nov. 29, 2005

(30) Foreign Application Priority Data
Jun. 4, 2003 (EP) 03101617.3

(51) Int. Cl. G06K 9/32

(52) U.S. Cl. 382/300

(57) ABSTRACT

In a method of interpolating sample values (f) of samples (Pi, Pot) of an image, a direction of a local gradient (8) of the sample values (f) for a particular one of the samples (Pi, Pot) is determined (1) from sample values (f) neighboring the particular one of the samples (Pi, Pot). The positions of interpolator input values (ai) are selected (20) in the direction of the local gradient (8) of the particular one of the samples (Pi, Pot). The interpolator input values (ai) for the particular one of the samples (Pi, Pot) are interpolated (21) from pixel values (f) neighboring the interpolator input values (ai). And, a warping factor (A) for a warped distance interpolating (3) is determined (22) using the interpolator input values (ai).

### FIELD OF THE INVENTION

The invention relates to a method of interpolating pixel values of pixels of an image. The invention further relates to a warped distance interpolator, and to a display apparatus comprising such a warped distance interpolator.

### BACKGROUND OF THE INVENTION

The warped distance concept (WaDi) is known from the publication “Warped distance for space-variant linear image interpolation”, IEEE Transactions on Image processing, vol. 8 no. 5, May 1999 by G. Ramponi. The Warped Distance concept for linear interpolators adapts a linear interpolator to the local pixel configuration of natural (non graphic) images. Particularly, the aim was to prevent edges from being blurred by the interpolation process.

The WaDi concept performs a one dimensional interpolation. In the horizontal direction, an interpolated sample could be a linear combination of the two neighboring horizontal samples sandwiching the sample to be interpolated. The linear combination depends on the fractional position (or phase) of the sample to be interpolated with respect to the two neighboring horizontal samples. The interpolation at a luminance edge is adapted by locally warping the phase, such that the sample to be interpolated is virtally moved toward the right or left input sample. This warping is stronger in presence of luminance edges and less on smooth parts. In order to determine the amount of warping, four pixels around the one that has to be interpolated are analyzed, and an asymmetry value is computed such that the sample to be interpolated is moved towards the flat area it belongs to.

An interpolation of a 2D image is obtained by first performing the WaDi algorithm on the input samples in the horizontal direction to obtain interpolated horizontal samples and then in the vertical direction on the interpolated horizontal samples. It is a disadvantage that a relatively complex algorithm is required.

### SUMMARY OF THE INVENTION

It is an object of the invention to perform a WaDi interpolation on a two-dimensional image which provides a higher performance algorithm.

A first aspect of the invention provides a method of interpolating sample values of samples of an image as claimed in claim 1. A second aspect of the invention provides a warped distance interpolator as claimed in claim 7. A third aspect of the invention provides a display apparatus as claimed in claim 8. Advantageous embodiments in accordance with the invention are defined in the dependent claims.

The method of interpolating sample values of samples of an image determines a direction of a local gradient for a particular one of the samples from sample values neighboring the particular one of the samples. This local gradient indicates the direction of change of the values of the samples at the position of the particular sample. For example if the image comprises a white left area and a black right area and the particular sample is near to a vertical border between the white and the black area, the gradient will direct in the horizontal direction towards the white area. Usually, the local gradient is determined for each output sample of the image.

Then, a warping factor for a warped distance interpolator WaDi is determined using interpolator input values arranged in the gradient direction of the particular sample. Thus, the interpolator input values for the well known WaDi interpolator are selected on a line which extends through the particular sample in the direction of the local gradient.

Because usually, these interpolator input values do not coincide with the input samples, the interpolator input values have to be interpolated from input sample values neighboring the interpolator input values.

The determination of the warping factor in the direction of the local gradient has the advantage that the WaDi interpolation can be performed in one step, instead of performing the WaDi interpolation step successively in the horizontal and vertical direction.

In an embodiment in accordance with the invention as defined in claim 2, the WaDi interpolation is applied in a system in which an output image is a scaled input image. This approach is particularly interesting for scaling factors which are at least 2, which means that the distance between the output samples is at most half of the distance between input samples. The distance may refer to the time elapsed between two successive samples or to the actual position on a display screen when these samples are displayed on the pixels of the display screen.

In this embodiment, the output image is first roughly interpolated from the input image to obtain raw interpolated data, for example by using a simple bilinear interpolator. The resultant low-pass version of the image makes the gradient estimation less susceptible to noise. A more complex interpolation, for example a cubic interpolation, may be used but has the drawback that a higher computational complexity results. The local gradient is determined by using the output pixels or raw interpolated data supplied by the simple interpolator.

In the embodiment in accordance with the invention as defined in claim 3, the local gradient is determined in the input map by using the input sample values. The local gradients found are mapped to output sample positions of the output samples in the output map. This mapping may be performed, for example, by using the nearest neighbor approach, or by linear interpolation. This approach does not require the raw interpolation step and thus takes less computational effort.

In the embodiment in accordance with the invention as defined in claim 4, the samples are arranged in a matrix in which the position of the samples is defined by the orthogonal x, y coordinates. Well known Sobel filters are used to estimate the direction of the local gradient.

In the embodiment in accordance with the invention as defined in claim 5, the distance between the adjacent interpolator input values used to determine the gradient is substantially equal to the distance between adjacent input samples to provide a coherent interpolation.

In the embodiment in accordance with the invention as defined in claim 6, the warping factor is projected on the x and y coordinates to control the WaDi interpolator to modify the distances (to warp the samples in the time domain or the pixels in the space domain) in the x and in the y direction in accordance with the projected warping actors. Thus, instead of performing the standard WaDi algorithm two times, first in the x direction to obtain intermediate results, and then in the y direction using the intermediate results, the components of the single warping factor are used to directly obtain the interpolated output samples from the input samples.

These and other aspects of the invention are apparent from and will be elucidated with reference to the embodiments described hereinafter.

### BRIEF DESCRIPTION OF THE DRAWINGS

In the drawings:

FIG. 1 shows a known two step interpolation approach,

FIG. 2 shows a waveform for elucidating the known Warped Distance concept,

FIG. 3 shows, for a particular output sample, the arrangement of the interpolator input values in the direction of the local gradient in accordance with an embodiment of the invention,

FIG. 4 shows a flowchart for elucidating an embodiment of the one step Warped Distance concept in accordance with the invention,

FIG. 5 shows a flowchart of part of another embodiment of the one step Warped Distance concept in accordance with the invention, and

FIG. 6 shows a block diagram of a display apparatus comprising the Warped Distance interpolator in accordance with the invention.

### DETAILED DESCRIPTION OF THE PREFERRED EMBODIMENT

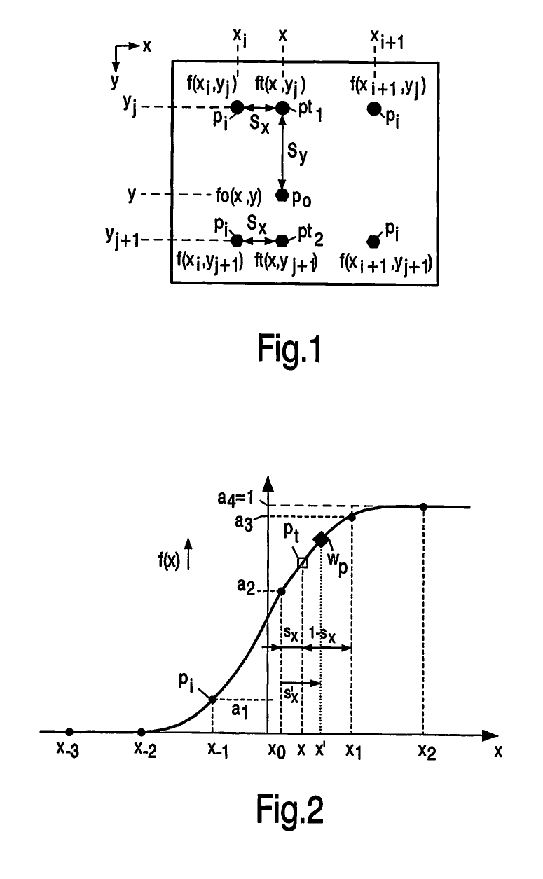

FIG. 1 shows a prior art two step interpolation approach.

In well known linear interpolation techniques, a two-dimensional input image II (see FIG. 6) is represented by input samples Pi which usually are sampled equidistant such that the input samples Pi are positioned on a rectangular grid which has a x and a y direction. The input samples Pi are also referred to as input pixels Pi which is based on the fact that if the input samples Pi were displayed on a display screen DS (see FIG. 6), the rectangular grid in time would show as a rectangular grid in position on the display screen DS. The values of the input samples Pi determine the intensity of the input pixels Pi. The output samples Po actually to be displayed on the display screen DS may have to be interpolated from the input samples Pi to obtain output pixels Po corresponding to the pixels on the display screen DS. This is for example required if the resolution of the display screen DS is fixed, such as is the case for matrix displays and the resolution of the input image II differs from the resolution of the display screen DS.

FIG. 1 shows the interpolation of an output sample Po which is positioned in-between input samples Pi. The value of the i-th input sample Pi of the j-th row of samples of the input image is denoted by f(xᵢ,yⱼ). The value of the output sample Po is denoted by fo(x,y). In FIG. 1 the four input samples Pi are shown which are nearest to the output sample Po.

First, the input image II is interpolated in the horizontal direction x. In the row yⱼ, the value ft(x,yⱼ) of a temporary sample Pt1 is determined using the value f(xᵢ,yⱼ) of the input sample Pi in the column xᵢ and the value f(xᵢ₊₁,yⱼ) of the input sample Pi in the column xᵢ₊₁. In the same manner, in the row yⱼ₊₁, the value ft(x,yⱼ₊₁) of a temporary sample Pt2 is determined using the value f(xᵢ,yⱼ₊₁) of the input sample Pi in the column xᵢ and the value f(xᵢ₊₁,yⱼ₊₁) of the input sample Pi in the column xᵢ₊₁. Then, the value fo(x,y) of the output pixel Po is determined using the temporary samples Pt1 and Pt2.

The values of the temporary samples Pt1 and Pt2 may be calculated as
ft(x,yₖ)=(1−Sₓ)f(xᵢ,yₖ)+Sₓf(xᵢ₊₁,yₖ) k=j,j+1 (1)
wherein Sₓ is the distance in the x-direction between x and xᵢ.

The value of the output sample Po may be calculated as
fo(x,y)=(1−S_{y})ft(x,yⱼ)+Sy ft(x,yⱼ₊₁) (2)
wherein S_{y} is the distance in the y-direction between y and yⱼ.

FIG. 2 shows a waveform for elucidating the known Warped Distance concept In the same manner as elucidated with respect to FIG. 1, the Warped Distance concept (further referred to as WaDi) determines the value of the output sample Po in two steps. The difference with the linear interpolation elucidated with respect to FIG. 1 is that the distances Sₓ and S_{y} are adapted (warped) according to a local feature of the input image II to increase the perceived quality of the interpolated output image OI (see FIG. 6). Thus, the WaDi interpolates the input image II by applying first the linear interpolation algorithm in the x-direction with an adapted distance Sₓ to obtain temporary or intermediate interpolated samples Pt. Then, the WaDi applies the linear interpolation algorithm in the y-direction on the intermediate interpolated samples Pt with an adapted distance S_{y} to obtain the output sample Po.

The WaDi warps the distances Sₓ and S_{y} based on de warping factor A:
A=(|a3−a1|−|a4−a2|)/(L−1) (3)
wherein the coefficients a1 to a4 are input sample values f(xi,yj) in the neighborhood of the output sample Po to be interpolated. Depending on the step performed by the WaDi, the input samples a1 to a4 are arranged either in the x or in the y direction. L is the number of levels available to display the samples, for example, for 8 bit luminance signals, L=256.

FIG. 2 shows a waveform and input samples Pi for elucidating the WaDi in the x-direction. The function f(x) shows an example of a transition in the input video image II.

Particularly, the aim of the WaDi was to prevent edges from being blurred by the interpolation process. If the intermediate sample Pt to be interpolated is in a position u (not shown) in the output domain, the corresponding position of the output sample Po in the input domain is x=u/z, wherein z is the scaling factor. The input domain comprises the input pixels Pi and the output domain comprises the output pixels Po. The fractional position or phase Sx=x−x₀, wherein x₀ is the left hand input sample Pi next to x. This input sample Pi at xo has a sample value a2, the input sample Pi at x₁ has the value a3, the input sample Pi at x₋₁ has the value a1 and the input sample Pi at x₂ has the value a4 which is 1 in the examples shown. If a simple tent (bilinear) kernel is applied as the base kernel of the linear interpolator of the WaDi, the output value would be:
ft(x)=(1−Sx)f(x₀)+Sxf(x₁)=(1−Sx)a2+Sxa3 (4)
wherein x₁ is the right hand input sample next to x.

Generally speaking, the interpolated sample ft(x) is a linear combination of the neighboring samples f(xₒ) and f(x₁), which linear combination depends on the fractional position (or phase) Sx. The interpolation at a luminance edge is adapted by locally warping the phase Sx, such that x is virtually moved toward the right or left input sample Pi. This warping is stronger in presence of luminance edges and less in smooth parts. In order to determine the amount of warping, the four samples Pi at positions x₋₁, x₀, x₁ and x₂ around the sample at position x that has to be interpolated are analyzed, and an asymmetry value or warping factor A is computed:

$$\begin{matrix}A = \frac{\vert f ( {x}_{1} ) - f ( {x}_{- 1} ) \vert - \vert f ( {x}_{2} ) - f ( {x}_{0} ) \vert}{L - 1} \\ = \frac{\vert a 3 - a 1 \vert - \vert a 4 - a 2 \vert}{L - 1}\end{matrix} \qquad ( 5 )$$

wherein L is the number of allowed luminance levels (256 in case of 8-bit quantization). And x₋₁ is the input sample preceding the input sample x₀, and x₂ is the input sample succeeding the input sample x₁. Provided the sigmoidal edge model applies, the asymmetry value A in equation (5) is 0 when the edge is perfectly symmetric, and close to 1 (or −1) when the edge is more flat in the right (left) hand side of the sample Pt.

The sample Pt to be interpolated should be moved towards the flat area it belongs to. Therefore, when the warping factor A>0, the phase Sx has to be increased, while if the warping factor A<0 the phase Sx has to be decreased. This is obtained by the following warping function:
Sx′=Sx−kASx(Sx−1) (6)
where k is the general amount of warping which may be controllable. The warped phase Sx′ remains in the range [0,1], if k is in the range [0,1]. It has to be noted that the two extremes Sx=0 and Sx−1 are maintained (Sx′=0 and Sx′=1, respectively), regardless the value of A and k. The warped intermediate sample is indicated as WP.

In the same manner as elucidated for determining the warped intermediate samples WP by performing the known WaDi in the x direction, the WaDi has to interpolate the warped intermediate samples WP in the y-direction to obtain the output sample Po.

Changing the phase Sx is equivalent to moving the position of the sample to be interpolated Pt or Po in the intermediate or output grid, respectively, before applying the linear filter equation of the WaDi, as if it were warped. Actually, the final position of the samples Pt or Po is not changed, the algorithm assigns to the sample to be interpolated Pt or Po the value obtained as if it were in the warped position. The factor k controls the amount of warping, a greater value of k increases the sharpening effect. To be sure that the phase Sx lies within the interval 0 to 1, the factor k has to be selected ≦1. But, for natural images, the factor k is preferably larger than 1. Because |A| is usually small, even at these larger factors k the phase Sx is still smaller than 1. If the phase Sx becomes larger than 1 it is clipped to 1, or if it becomes smaller than 0 it is clipped to 0.

In an embodiment in accordance with the invention, compared to the known WaDi, the warping function is determined only once, in the direction of a local gradient (θ) in either the input image or the output image.

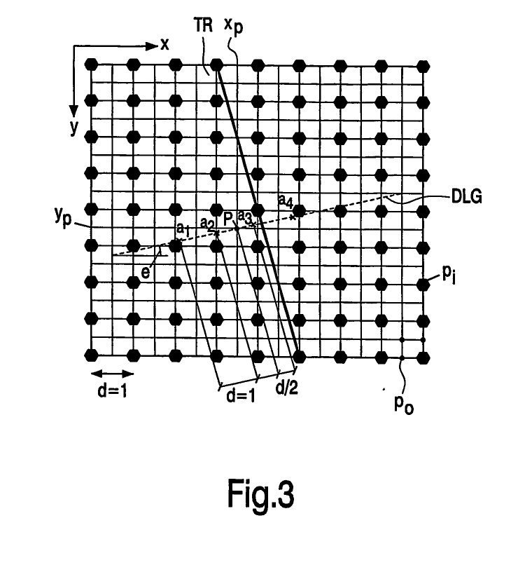

FIG. 3 shows, for a particular output sample, how the interpolator input values a1 to a4 may be arranged in the direction of the local gradient in accordance with an embodiment of the invention. The input samples Pi are indicated by the large dots spaced over distance d in the x, y space. The output samples Po are indicated by the intersections of the horizontal and vertical lines which form the output grid. FIG. 3 thus shows, by way of example, a scaling with a factor 2. The line TR indicates the border between a black area (at the left hand side of the border TR) and a white area. The direction of the local gradient at the position of the output pixel P is indicated by the dotted line DLG which is perpendicular to the border TR.

The invention is based on changing the phases Sx and Sy, not according to local 1-dimensional features in the x or the y direction, respectively, but from 2-dimensional features. Thus, the warping factor A is calculated in one step along the local gradient direction θ which may be diagonal. It is not required to determine a factor A separately in the x-direction and in the y-direction.

As discussed with respect to the known WAiD the asymmetry value or warping factor A is still calculated by using input values a1 to a4 which are positioned in the neighborhood of the output sample P of which the value has to be determined. But, in accordance with an embodiment of the invention, these input values are neither the input samples Pi in the x-direction nor the warped temporary samples Pt in the y-direction. Now, the input values a1 to a4 are arranged in the direction of a local gradient θ. As shown in FIG. 3, the input values a1 to a4 used to determine the warping factor A are positioned on the line DLG, thus in the direction of the local gradient θ. Usually, these input values a1 to a4 will not coincide with input samples Pi and thus will have to be interpolated from the input samples Pi. Preferably, the distance d between two successive ones of the input values a1 to a4 is equal to the sampling period of the samples Pi of the input image II to keep coherence with the image interpolation stage.

This sampling period corresponds to the distance d between two successive input samples Pi in either the x or the y direction. For example, the input values a1 to a4 are obtained by a bilinear interpolation in the positions shown in FIG. 3. These positions of the input values a1 to a4 are selected along the maximum gradient direction θ, at distances −1.5·d, −0.5·d, 0.5·d, 1,5·d, respectively, from the (xp,yp) position of the output pixel P to be interpolated, wherein d is the distance between two successive input pixels Pi in the input grid. The coordinates x and y of the input values a1 to a4 are determined with the following equations:
x=xₚ+(i−2.5)d·cos(θ)
y=yₚ+(i−2.5)d·sin(θ)
wherein i is the index of the input value a₁.

Two possible embodiments are elucidated for determining the local gradient θ. In the first embodiment, the input image II is first interpolated with a known algorithm, for example with a bilinear filter, to obtain roughly interpolated output samples. The local gradient θ is determined in the output domain from these output samples. For example, by using a Sobel filter. Possible masks of Sobel filters to obtain a value of the directional derivative along x and y directions are:

$${Sobel}_{x} = ( \begin{matrix}1 / 4 & 0 & - 1 / 4 \\ 1 / 2 & 0 & - 1 / 2 \\ 1 / 4 & 0 & - 1 / 4\end{matrix} )$$

$${Sobel}_{y} = ( \begin{matrix}- 1 / 4 & - 1 / 2 & - 1 / 4 \\ 0 & 0 & 0 \\ 1 / 4 & 1 / 2 & 1 / 4\end{matrix} )$$

The direction of the gradient θ at the position xᵢ,yⱼ is then estimated as follows:
θ(x₁,yⱼ)=arctan((f1*Sobel_{y})|(x₁,yⱼ)/(f1*Sobelₓ)|(x₁,yⱼ)) (7)
wherein f1 is the result of the rough interpolation of the input image II, and θ is an angle which varies between −π/2 and π/2.

The gradient evaluation has been performed by using Sobel's method in the output domain. A pre-processing, for example a simple bilinear interpolator, is required to obtain raw interpolated output samples which represent a low-pass version of the input image II and thus the gradient estination is less noise-sensitive. The rough interpolation may be performed with more complex methods, for example, such as a bicubic interpolation, which of course has the drawback that a higher computational complexity is required but which provides better gradient values θ. Although this first embodiment provides a very good gradient estimate, it adds a considerable overhead to the total processing time.

In another embodiment, a less optimal solution to estimate the gradient θ is to apply the Sobel filters in the input domain (using the input samples Pi) and then map these gradient values to the output grid. This mapping may be performed, for example, by using the nearest neighbor approach, or by linearly interpolating the estimated gradient values θ.

If very high values of the interpolation factor are required, the pass band of Sobel filter could become too large and the gradient estimation would not work. For high interpolation factors, it is thus better to resize the image in two steps, performing the whole algorithm twice. For example, an interpolation by a factor of 8 may become an interpolation by a cascade of interpolations by a factor of 2. Alternatively, the Sobel filters may be used to process a mid-resolution version of the input image II to obtain gradient values θ. The same gradient values θ are assigned to a group of output pixels Po in the ultra-high resolution output grid.

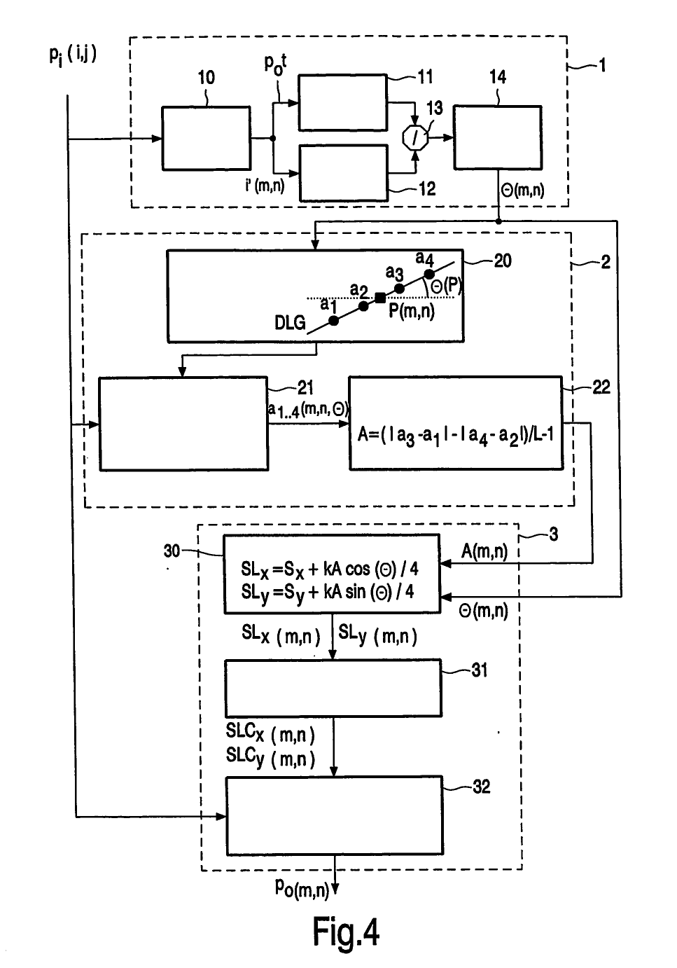

FIG. 4 shows a flowchart for elucidating an embodiment of the one step Warped Distance concept in accordance with the invention.

The step 1 receives the input samples Pi(i,j) and supplies local gradients θ(m,n) (also referred to as gradients). In the first embodiment as elucidated before, the step 10 interpolates the input pixels Pi(i,j) to obtain estimated output samples I′(m,n) which are inputted into the Sobelₓ filtering step 11 and the Sobel_{y} filtering step 12. In the dividing step 13, the output of the Sobel_{y} filtering step 12 is divided by the output of the Sobelₓ filtering step 11. Step 14 determines the gradient θ(m,n) by calculating the arctan of the output of the dividing step 13.

The step 2 performs the local asymmetry estimation also referred to as the determination of the warping factor A. In step 20, the four input values a1 to a4 are selected to be determined in positions along the direction of the local gradient θ, thus on the line DLG. P(m,n) is the output sample of which the value has to be interpolated, and θ(P) is the local gradient at the position of this output sample P(m,n). In step 21, the values of the input values a1 to a4 are determined by interpolation of the input samples Pi surrounding the positions of the input values a1 to a4. Preferably, a bilinear interpolation is used. In step 22, the warping factor A is determined according to equation 5 in one step from the interpolated input values a1 to a4.

The step 3 determines the values of the output samples Po(i,j). Step 30 receives the gradients θ(m,n) and the warping factor A to compute the local warping components or distances SLₓ and Sl_{y} by warping the distances Sₓ and S_{y} in the same manner as equation 6 did for the known WaDi approach. To obtain the result, the warping vector A is projected onto the x and y direction. The following equations perform these operations:
SLₓ=Sₓ+kA cos (θ)/4 (8)
SL_{y}=S_{y}+kA sin (θ)/4 (9)

As in the known WaDi approach, k is a multiplying factor that adjusts the distortion intensity, θ is the angle which defines the gradient direction. The optional factor 4 at the denominator is provided only for comparison with the known WaDi results. Note that the k factor can be varied on a sample-per-sample (or if referring to the output pixels on a pixel by pixel) basis, by means of an (external) automatic control. For example, a natural content detector can be used to estimate the probability whether the local pixel is part of a photograph. Depending on this estimate the warping effect can be tuned via the k factor to obtain the best result.

The optional clipping step 31 clips the values of the local warping distances SLx and Sly to keep them in a range from zero to one, including the limits. Otherwise, it may happen, especially if the multiplying factor k>4, that the warping distances SLx or SLy are smaller than zero or greater than one which means that the output pixel Po to be interpolated would move outside the square formed by the four nearest input pixels Pi, which will not provide a good interpolation. The clipped warping distances are denoted by SLCx and SLCy.

It has to be noted that based on equations 8 and 9, that if the phase Sx=0 and the phase Sy=0, and if A is not zero, the warping distances SLx and SLy may not be equal to zero. Thus, output pixels Po(m,n) interpolated in points of the output grid that correspond to points in the input grid may have a value different from the corresponding input samples Pi(i,j). Therefore, the adapted WaDi algorithm in accordance with the invention is an approximate interpolation algorithm.

The interpolation step 32 interpoltes the input samples Pi(i,j) with an interpolator which preferably uses a linear kernel. The clipped warping distances SLCx and SLCy determine how the output sample Po(m,n) has to be interpolated by weighting the adjacent input samples Pi(i,j) in the same manner as in the know WaDi.

The warped position x′,y′ in which the value f(x′,y′) of the output sample or pixel Po(x,y) has to be evaluated is influenced by three factors:

the coordinates x,y of the output pixel Po we are interpolating,

the direction θ of the local gradient which constrans the position of the input values ai used to calculate the warping factor A, and

the value of the warping strength parameter k.

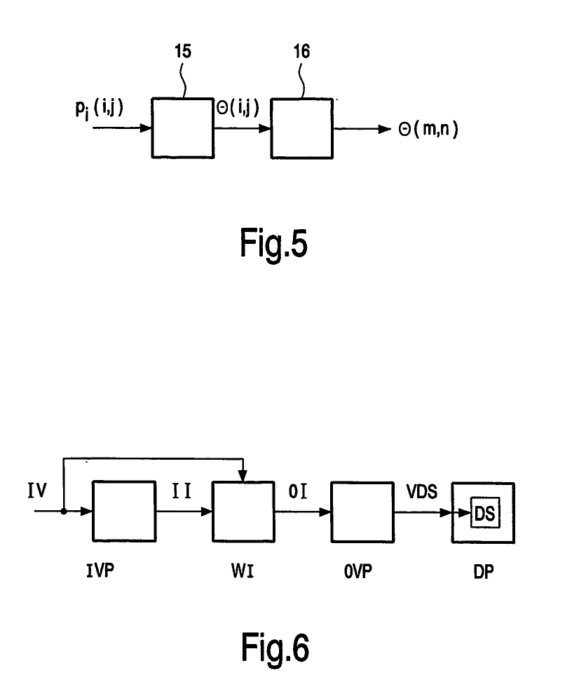

FIG. 5 shows a flowchart of part of another embodiment of the one step Warped Distance concept in accordance with the invention. FIG. 5 shows the steps required in the step 1 which determines the direction of the local gradient θ(m,n) in accordance with the second embodiment discussed before. Now, step 1 comprises the steps 15 and 16 instead of the steps 10 to 14 shown in FIG. 4. In step 15, the direction of the local gradients θ(i,j) is determined in the input image II for the input samples Pi. The step 16 maps these local gradients θ(i,j) from the input domain to the output domain to obtain local gradients θ(m,n) for the output pixels Po. The other steps of the WaDi processing of this embodiment in accordance with the invention are equal to the steps shown in FIG. 4.

FIG. 6 shows a block diagram of a display apparatus comprising the Warped Distance interpolator in accordance with the invention. An input video processor IVP processes input video IV to obtain the input image II comprising the input samples Pi. If the input video IV comprises the three RGB signals, the input video processor IVP may comprise a matrix for determining the luminance value. The scaler WI comprises the WaDi interpolator in accordance with the invention which is the known WaDi interpolator which is adapted to be able to process two dimensional input images II in one step. The scaler WI supplies the output image OI which comprises the output samples Po. Such a scaler is usually required in display apparatuses which comprise a matrix display. Such a matrix display has a native resolution determined by the number of pixels (display elements) in each row and the number of rows. On the other hand, the input image II has a resolution which may differ from the native resolution of the matrix display. Thus, the output samples Po to be displayed on the pixels of the matrix display have to be interpolated from the input samples Pi. The scaler WI may receive the input video IV to be able to interpolate each of the three signals R, G and B, if present. The output video processing processes the output video OI to obtain a video drive signal VDS suitable to drive the display device DP comprising the display screen DS.

To conclude, the preferred embodiment in accordance with the invention is directed to a digital processor which performs the next steps in the order given.

Interpolate 10 the input image II with a predetermined fast interpolation method to obtain a roughly interpolated output image I′(m,n) comprising temporary output samples Pot. The temporary output samples Pot are determined for the purpose of using them to calculate the local gradient direction θ(m,n) and are not meant to be displayed.

Calculate the local gradient direction θ(m,n) in this roughly interpolated output image I′(m,n) with a simple algorithm such as the Sobel filters 11 and 12, the divider 13 and the arctan calculator 14, but other algorithms may also be used.

Determine 21 a number of interpolated input values ai along this gradient direction θ(m,n) from the input samples Pi(i,j) of the input image II in selected 20 predetermined positions located around the output pixel Po(m,n) we want to interpolate. Use these input values ai to match the edge model of the WaDi approach by calculating 22 the warping factor A. Use this warping factor A to calculate the warping along the gradient direction θ(m,n).

Project 30 the calculated warping along the gradient direction θ(m,n) on the x and y axis, and perform a clipping 31 if necessary. Apply 32 the projected x and y warping components on the values of the phases Sx and Sy (representing the offset of the output samples Po(m,n) to be interpolated with respect to the closest upper-left input pixels Pi(i,j)) to calculate the warped position of the output sample Po(m,n). Use 32 a linear filtering technique to interpolate the output sample value Po(m,n) in the warped position accordingly. The output samples Po(m,n) are used to be displayed.

The WaDi algorithm in accordance with the invention could be used every time an interpolation processing is required of photographic images or video. The algorithm performs best when scaling factors greater than 2 are required. For example, the algorithm may be used in video-wall applications, in photo-retouching software and other context. It could also be useful inside integrated circuits, such as, for example controllers of digital display systems. The algorithm could be implemented both in real time and batch processing applications.

It should be noted that the above-mentioned embodiments illustrate rather than limit the invention, and that those skilled in the art will be able to design many alternative embodiments without departing from the scope of the appended claims.

Although the WaDi processing in accordance with the invention has been described for grey scale images, the same processing can be used for color images. If the WaDi processor receives RGB (Red, Green and Blue) input signals, the warped distances Six and SLy may be calculated by using the luminance value determined from the RGB input signals. The difference is that in the last step 32, the interpolation is applied three times, on each one of the RGB signals separately using the same values of the warped distances SLx and SLy or the clipped warped distances SLCx, SLCy.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of interpolating sample values (f) of samples (Pi, Pot) of an image, the method comprising:
determining (1) a direction of a local gradient (θ) of the sample values (f) for a particular one of the samples (Pi, Pot) from sample values (f) neighboring the particular one of the samples (Pi, Pot),
selecting (20) a position of interpolator input values (ai) in the direction of the local gradient (θ) of the particular one of the samples (Pi, Pot),
interpolating (21) the interpolator input values (ai) for the particular one of the samples (Pi, Pot) from sample values (f) neighboring the interpolator input values (ai), and
determining (22) in a single step a warping factor (A) for a warped distance interpolator (3) using the interpolator input values (ai).

2. A method of interpolating sample values (f) of samples (Pi, Pot) of an image as claimed in claim 1, wherein:
an output image (OI) is interpolated from an input image (II) in a system for digitally scaling the input image (II) with input samples (Pi) having input sample values to obtain the output image (OI) with output samples (Po),
the method further comprises interpolating (10) the input sample values to obtain interpolated temporary output samples (Pot) having temporary output sample values (I′(m,n)),
the determining (1) the direction of the local gradient (θ) is arranged for determining a direction of the local gradient (θ) for each one of the output samples (Po) from neighboring temporary output sample values (I′(m,n)).

3. A method of interpolating sample values (f) of samples (Pi, Pot) of an image as claimed in claim 1, wherein:
an output image (OI) is interpolated from an input image (II) in a system for digitally scaling the input image (II) with input samples (Pi) to obtain the output image (OI) with output samples (Po),
the determining (1) the direction of the local gradient (θ) is arranged for determining (15) a direction of the local gradient (θ) for each one of the input samples (Pi) from neighboring input sample values to obtain input sample gradient values, and
the method further comprises mapping (16) of the input sample gradient values to output gradient values of the output samples (Po), wherein the corresponding one of the output gradient values is used as the local gradient (θ) of the particular one of the samples (Pi, Pot).

4. A method of interpolating sample values (f) of samples (Pi, Pot) of an image as claimed in claim 2, wherein the input samples (Pi) and the output samples (Po) are arranged in a matrix comprising rows of pixels in an x direction and columns of pixels in a y direction, the determining (1) the direction of the local gradient (θ) comprises a first Sobel filtering (11) of the temporary output samples (Pot) in the x direction and a second Sobel filtering (12) in the y direction, the local gradient (θ) of the output samples (Po) being the arctangent of the second Sobel filtering (12) divided by the first Sobel filtering (11).

5. A method of interpolating sample values (f) of samples (Pi, Pot) of an image as claimed in claim 2, wherein a distance (d) between adjacent interpolator input values (ai) is substantially equal to a distance between adjacent input samples (Pi).

6. A method of interpolating sample values (f) of samples (Pi, Pot) of an image as claimed in claim 2, wherein:
the input samples (Pi) and the output samples (Po) are arranged in a matrix comprising rows of pixels in an x direction and columns of pixels in a y direction, and
the determining (22) a warping factor (A) comprises projecting (30) the warping factor (A) on a x and y axis to obtain first and second warping components (Ax, Ay), respectively, and an interpolator (32) for interpolating the input samples (Pi) with modified distances determined by the first and second warping components (Ax, Ay).

7. A warped distance interpolator for interpolating sample values (f) of samples (Pi, Pot) of an image, said interpolator comprising:
means for determining (1) a direction of a local gradient (θ) of the sample values (f) for a particular one of the samples (Pi, Pot) from sample values (f) neighboring the particular one of the samples (Pi, Pot),
means for selecting a position (20) of interpolator input values (ai) in the direction of the local gradient (θ) of the particular one of the samples (Pi, Pot),
means for interpolating (21) the interpolator input values (ai) for the particular one of the samples (Pi, Po) from pixel values (f) neighboring the interpolator input values (ai), and
means for determining (22) in a single step a warping factor (A) for a warped distance interpolator (3) using the interpolator input values (ai).

8. A display apparatus comprising the warped distance interpolator (3) of claim 7, and a display screen (DS).
